(19) United States
(12) Patent Application Publication
(10) Pub. No.: US 2007/0155897 A1
(43) Pub. Date: Jul. 5, 2007

(54) Coating film having low refractive index and large water contact angle

(75) Inventors: Yoshihiro Tani, Funabashi-shi (JP); Kenichi Motoyama, Funabashi-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Nissan Chemical Industries Limited, Tokyo (JP)

(21) Appl. No.: 10/583,559

(22) PCT Filed: Dec. 17, 2004
(86) PCT No.: PCT/JP04/18922

§ 371 Date: Jun. 19, 2006

(30) Foreign Application Priority Data
Dec. 19, 2003 (JP) 2003-421828

(51) Int. Cl. B05D 3/02; C08K 3/22; B60C 1/00; C08G 77/06

(52) U.S. Cl. 524/837; 427/384; 524/430; 524/492

(57) ABSTRACT

To provide a process for forming an improved coating film on a substrate, particularly to provide a coating film formed on a substrate, as adhered to the surface of the substrate, having a refractive index of from 1.28 to 1.38 and a contact angle with water of from 90° to 115°.

A coating film having a refractive index of from 1.28 to 1.38 and a contact angle with water of from 90° to 115°, which is formed as adhered to a substrate surface by forming a reaction mixture comprising a silicon compound (A) of the formula Si(OR)₄, a silicon compound (B) of the formula (R¹O)₃SiCH₂CH₂(CF₂)ₙCH₂CH₂Si(OR¹)₃, an alcohol (C) of the formula R²CH₂OH, and oxalic acid (D), in a specific ratio; heating this reaction mixture at a temperature of from 50 to 180° C. in the absence of water, to form a solution of a polysiloxane; then applying a coating fluid comprising the polysiloxane solution on a substrate surface to form a coating; and heat-curing the coating at a temperature of from 80 to 450° C.; a method for forming such a coating film; and a process for producing such a coating fluid.

### TECHNICAL FIELD

The present invention relates to an improvement of a coating film formed on a substrate from a polymer solution of alkoxy group-containing silicon compounds. Particularly, the present invention relates to a coating film having a low refractive index and a large contact angle with water, which is formed as adhered to a substrate surface by heat-curing on the substrate surface a coating comprising a solution of a polysiloxane prepared by co-polycondensing alkoxy group-containing silicon compounds having a specific composition, in the absence of water.

### BACKGROUND ART

It is known that when a coating film showing a refractive index lower than the refractive index of a substrate is formed on the surface of the substrate, the reflectance of light reflected from the surface of the coating film decreases. Such a coating film showing a decreased light reflectance is utilized as an antireflection film and practically applied to various substrate surfaces.

A process for forming an antireflection film having a low refractive index, on a substrate, is disclosed which comprises applying on a glass substrate such as a cathode ray tube an alcohol dispersion of fine particles of MgF₂ formed by reacting a magnesium salt or an alkoxy magnesium compound as a Mg source with a fluoride salt as a F source, or a liquid having tetraalkoxysilane or the like added thereto for improving the film strength, as a coating fluid, followed by heat-treatment at a temperature of from 100° C. to 500° C. (Patent Document 1).

A low reflection glass having formed on a glass substrate a thin film showing a refractive index of from 1.21 to 1.40 and having a thickness of from 60 to 160 nm with irregularities or micro-pits having a diameter of from 50 to 200 nm, is disclosed, wherein the film is formed by mixing a solvent such as an alcohol with at least two hydrolytic polycondensates different in the average molecular weight, such as tetraalkoxysilane, methyltrialkoxysilane, to obtain a coating fluid, forming a coating film from such a coating fluid by controlling the relative humidity and the mixing ratio at the time of the above mixing, and heating the coating film (Patent Document 2).

A low reflectance glass comprising a glass, a lower layer film having a high refractive index formed on its surface and an upper layer film having a low refractive index formed on the surface thereof, is disclosed (Patent Document 3). As a detailed description of the process for forming the upper layer film, this publication discloses a process which comprises hydrolyzing a fluorine-containing silicone compound having a polyfluorocarbon chain such as CF₃(CF₂)₂C₂H₄Si(OCH₃)₃ and a silane coupling agent such as Si(OCH₃)₄ in an amount of from 5 to 90 wt % based thereon, in an alcohol solvent in the presence of a catalyst such as acetic acid, followed by filtration to obtain a liquid of a co-polycondensate, then applying this liquid on the lower layer film and heating it at a temperature of from 120 to 250° C.

A coating film having a refractive index of from 1.28 to 1.38 and a contact angle with water of from 90° to 115°, is disclosed which is formed as adhered on a substrate surface, by preparing a reaction mixture comprising a silicon compound of the formula Si(OR)₄, a silicon compound of the formula CF₃(CF₂)ₙCH₂CH₂Si(OR¹)₃, an alcohol of the formula R²CH₂OH and oxalic acid in a specific ratio, heating this reaction mixture at a temperature of from 40 to 180° C. in the absence of water to form a solution of a polysiloxane, applying a coating fluid containing the solution on a substrate surface to form a coating, and heat-curing the coating at a temperature of from 80 to 450° C. (Patent Document 4).

Patent Document 1: JP-A-05-105424

Patent Document 2: JP-A-06-157076

Patent Document 3: JP-A-61-010043

Patent Document 4: JP-A-09-208898

### DISCLOSURE OF THE INVENTION

### Problems to be Solved by the Invention

The process for forming a multilayer coating film on a substrate as disclosed in the above Patent Document 3, requires repetition of the coating and baking steps, and is not efficient. Besides, due to repetition of the baking step, cracks are likely to form in the coating film, the resulting coating film tends to be non-uniform, and deformation of the substrate is likely to occur. Further, in order to impart a low refractive index to the upper layer film formed from the coating fluid obtained by such as hydrolytic method, it is required to use a large amount of the fluorine-containing silicone compound at a level of at least 1.1 mol per mol of the silane coupling agent, and even in such a case, a coating film having a refractive index lower than 1.33 is hardly obtainable. Further, if the coating fluid obtained by such a hydrolytic method, is directly applied on the substrate, and the coating is heated, the resulting coating film, will not have sufficient hardness.

By the process disclosed in the above Patent Document 1, the bond strength among the fine particles of MgF₂ is weak, so that the formed coating film is poor in the mechanical strength, and the adhesive strength to the substrate is inadequate. Besides, this coating film made of MgF₂ does not essentially show a refractive index lower than 1.38, and depending upon the type of the substrate, no adequate antireflection property can be obtained. The process disclosed in the above Patent Document 2 is cumbersome in the preparation and incorporation of the polycondensates having different molecular weights and further requires control of the relative humidity during the film-forming and the surface irregularities of the coating film. Thus, this process is not practically useful.

Each of the coating films disclosed in the above Patent Documents 1 and 2 is susceptible to staining of its surface during practical use, and to prevent such staining, it has been common to apply a treating agent having higher water repellency on its surface, such as a stain-proofing agent made of a fluorine-containing compound.

The coating film disclosed in the Patent Document 4 forms a highly hard and highly water repellent low reflection coating film when applied to a plastic film having irregularities formed on its surface, like an antiglare-treated hard coat-covered triacetylcellulose (TAC) film. However, the hardness tends to be inadequate when it is formed on a film having a smooth surface such as a clear hard coat-covered TAC film.

It is an object of the present invention to provide a process for simply and efficiently forming an improved coating film on a substrate, particularly to provide a coating film formed on a substrate, as adhered to the surface of the substrate and having a refractive index of from 1.28 to 1.38 and a contact angle with water of from 90° to 115°.

### MEANS TO SOLVE THE PROBLEMS

The coating film of the present invention is a coating film having a refractive index of from 1.28 to 1.38 and a contact angle with water of from 90° to 115°, which is formed as adhered to a substrate surface by forming a reaction mixture comprising a silicon compound (A) of the formula (1):
Si(OR)₄ (1)
wherein R is a C₁₋₅ alkyl group, a silicon compound (B) of the formula (2):
(R¹O)₃SiCH₂CH₂(CF₂)ₙCH₂CH₂Si(OR¹)₃ (2)
wherein R¹ is a C₁₋₅ alkyl group, and n is an integer of from 1 to 13, an alcohol (C) of the formula (3):
R²CH₂OH (3)
wherein R² is a hydrogen atom or a C₁₋₁₂ alkyl group (the alkyl group may optionally be substituted by one or more substituents of the same or different types selected from the group consisting of a C₁₋₃ alkyl group, a C₁₋₃ hydroxyalkyl group, a C₂₋₆ alkoxyalkyl group, a C₂₋₆ hydroxyalkoxyalkyl group and a C₃₋₆ alkoxyalkoxyalkyl group), and oxalic acid (D), in a ratio of from 0.05 to 0.43 mol of the silicon compound (B) per mol of the silicon compound (A), in a ratio of from 0.5 to 100 mol of the alcohol (C) per mol of the total alkoxy groups contained in the silicon compounds (A) and (B) and in a ratio of 0.2 to 2 mol of the oxalic acid (D) per mol of the total alkoxy groups contained in the silicon compounds (A) and (B); heating this reaction mixture at a temperature of from 50 to 180° C. until the total amount of the silicon compounds (A) and (B) remaining in the reaction mixture becomes at most 5 mol %, while it is maintained at a SiO₂ concentration of from 0.5 to 10 wt % as calculated from silicon atoms in the reaction mixture and while absence of water is maintained, to form a solution of a polysiloxane thereby formed; then applying a coating fluid comprising the polysiloxane solution on a substrate surface to form a coating; and heat-curing the coating at a temperature of from 80 to 450° C.

The above mentioned polysiloxane solution is transparent and contains no gelled polysiloxane. This polysiloxane is not one formed by condensation of hydrolysates of the silicon compounds (A) and (B), since the silicon compounds (A) and (B) are heated in a reaction mixture wherein no water is present, although a large amount of the alcohol (C) and a relatively large amount of oxalic acid (D) are present. When a polysiloxane is formed from an alkoxysilane by hydrolysis in an alcohol solvent, it is likely that the liquid will be turbid as the hydrolysis proceeds, or a non-uniform polysiloxane will form. However, with the above reaction mixture by the present invention, no such a phenomenon will take place.

With respect to the above polysiloxane by the present invention, its chemical structure is complex and can hardly be specified. However, it is considered that the polymerization proceeds as the alcohol (C) will act on an intermediate formed by a reaction of the silicon compounds (A) and (B) with the oxalic acid (D), whereby a co-polycondensate polysiloxane of the silicon compounds (A) and (B) will be formed which has a polymerization degree of a level to form a solution and which has a relatively uniform structure, although it may have a branched structure.

By heating a coating containing the above polysiloxane solution applied on the substrate, removal of a volatile component from the coating and a curing reaction of the polysiloxane in the coating will proceed thereby to form an insoluble coating film as adhered to the substrate surface and having a low refractive index and water repellency.

As the molar ratio of the amount of the silicon compound (B) to the amount of the silicon compound (A) becomes large, the refractive index of this coating film becomes low, and the contact angle with water becomes large. However, as is different from the upper layer film disclosed in the above Patent Document 3, the coating film of the present invention has a refractive index lower than the refractive index of such an upper layer film, in spite of the fact that it is formed from a coating fluid having a low content of the silicon compound (B).

### EFFECTS OF THE INVENTION

The polysiloxane solution to be used for forming the coating film of the present invention has stability durable for storage for about six months at room temperature and thus may be presented as an industrial product. And, the coating film of the present invention can easily be obtained by a step of applying on a substrate surface a coating fluid comprising such a solution as the industrial product and a step of heat-curing the coating.

By forming the coating film of the present invention on a substrate having a refractive index higher than the refractive index of the coating film of the present invention, such as on a usual glass surface, it is easily possible to convert such a substrate to an antireflective substrate. The thickness of the coating film of the present invention may be adjusted by the thickness of the coating, but it can easily be adjusted by adjusting the SiO₂ concentration in the coating fluid. The coating film of the present invention may be used effectively as a single coating film on the substrate surface, but it may also be used as an upper layer coating film on a lower layer coating film having a high refractive index.

It is known that a relational expression of d=(2b−1)λ/4a (wherein b is an integer of at least 1) is satisfied between the thickness d (nm) of the coating film having a refractive index a and the wavelength λ (nm) of light, of which a decrease in reflectance by this coating film is desired. Accordingly, by setting the thickness of the coating film by utilizing this expression, it is readily possible to prevent reflection of any desired light. For example, it is easily possible to accomplish prevention of reflection from a glass surface of light having a center wavelength 550 nm of visible light by a coating film having a refractive index of 1.32, by adopting a coating film thickness of 104 nm obtained by substituting such numerical values for λ and a in the above formula and substituting 1 for b, or a coating film thickness of 312 nm obtained by substituting 2 for b. The coating film of the present invention can be applied to the surface of a cathode ray tube made of glass, a display of a computer, a mirror having a glass surface, a showcase made of glass or various other products, which are desired to have reflection of light prevented. The coating film of the present invention is highly hard and excellent in scratch resistance and has a practically sufficient antifouling property, and it can be formed by baking at a low temperature at a level of about 100° C. Accordingly, it is useful particularly for an antireflection film for a liquid crystal TV or a display monitor.

### BEST MODE FOR CARRYING OUT THE INVENTION

Examples of the alkyl group R in the above formula (1) include methyl, ethyl, propyl, butyl and pentyl. Preferred examples of the silicon compound (A) include tetramethoxysilane, tetraethoxysilane, tetrapropoxysilane and tetrabutoxysilane. Among them, particularly preferred are tetramethoxysilane and tetraethoxysilane.

Examples of the alkyl group R¹ in the above formula (2) include methyl, ethyl, propyl, butyl and pentyl. Preferred examples of the silicon compound (B) include 1,1-bis(trimethoxysilylethyl)perfluoromethane, 1,1-bis(triethoxysilylethyl)perfluoromethane, 1,2-bis(trimethoxysilylethyl)perfluoroethane, 1,2-bis(triethoxysilylethyl)perfluoroethane, 1,3-bis(trimethoxysilylethyl)perfluoropropane, 1,3-bis(triethoxysilylethyl)perfluoropropane, 1,4-bis(trimethoxysilylethyl)perfluorobutane, 1,4-bis(triethoxysilylethyl)perfluorobutane, 1,5-bis(trimethoxysilylethyl)perfluoropentane, 1,5-bis(triethoxysilylethyl)perfluoropentane, 1,6-bis(trimethoxysilylethyl)perfluorohexane, 1,6-bis(triethoxysilylethyl)perfluorohexane, 1,7-bis(trimethoxysilylethyl)perfluoroheptane, 1,7-bis(triethoxysilylethyl)perfluoroheptane, 1,8-bis(trimethoxysilylethyl)perfluorooctane and 1,8-bis(triethoxysilylethyl)perfluorooctane. These compounds may be used alone or in combination as a mixture of two or more of them.

Examples of the unsubstituted alkyl group R² in the above formula (3) include methyl, ethyl, propyl, butyl, pentyl, hexyl, heptyl and octyl. Examples of the substituted alkyl group R² include hydroxymethyl, methoxymethyl, ethoxymethyl, hydroxyethyl, methoxyethyl, ethoxyethyl, methoxyethoxymethyl and ethoxyethoxymethyl. Preferred examples of the alcohol (C) include methanol, ethanol, propanol, n-butanol, ethylene glycol monomethyl ether, ethylene glycol monoethyl ether, diethylene glycol monomethyl ether and diethylene glycol monoethyl ether. These alcohols may be used alone or in combination as a mixture of two or more of them. Among them, particularly preferred are methanol and ethanol.

A uniform polysiloxane solution is hardly obtainable from a reaction mixture in which the silicon compound (B) is used in an amount exceeding 0.43 mol per mol of the silicon compound (A). From a reaction mixture wherein the silicon compound (B) is used in an amount of less than 0.05 mol per mol of the silicon compound (A), a coating film having a refractive index of 1.38 or less will hardly be formed, and the coating film thereby formed will not exhibit water repellency showing a contact angle with water of at least 90°. It is particularly preferred that the silicon compound (B) is used in an amount of from 0.05 to 0.25 mol per mol of the silicon compound (A).

If the alcohol is used in an amount less than 0.5 mol per mol of the total alkoxy groups contained in the silicon compounds (A) and (B), it takes a long time to form the polysiloxane, and it tends to be difficult to form a coating film having high hardness from the liquid containing the polysiloxane thereby obtained. On the other hand, if the alcohol is used in an amount more than 100 mol per mol of the total alkoxy groups contained in the silicon compounds (A) and (B), the SiO₂ concentration in the obtained polysiloxane-containing liquid tends to be inadequate, and concentration will be required prior to coating, such being inefficient. It is particularly preferred to use the alcohol in an amount of from 1 to 50 mol per mol of the total alkoxy groups contained in the silicon compounds (A) and (B).

If oxalic acid (D) is used in an amount smaller than 0.2 mol per mol of the total alkoxy groups contained in the silicon compounds (A) and (B), it tends to be difficult to form a coating film having high hardness from the resulting polysiloxane-containing liquid. On the other hand, if the oxalic acid (D) is used in an amount more than 2 mol per mol of the total alkoxy groups contained in the silicon compounds (A) and (B), the resulting polysiloxane-containing liquid contains a relatively large amount of the oxalic acid (D), and from such a liquid, it tends to be difficult to obtain a coating film having the desired properties. It is particularly preferred to use the oxalic acid (D) in an amount of from 0.25 to 1 mol per mol of the total alkoxy groups contained in the silicon compounds (A) and (B).

In the formation of the reaction mixture, an alkylalkoxysilane may be incorporated as a modifier (E), for example, in an amount of from 0.02 to 0.2 mol per mol of the silicon compound (A), as the case requires, in addition to the silicon compounds (A) and (B), the alcohol (C) and the oxalic acid (D). Preferred examples of the modifier (E) include trialkoxysilanes such as methyltrimethoxysilane, methyltriethoxysilane, ethyltrimethoxysilane, ethyltriethoxysilane, propyltrimethoxysilane, propyltriethoxysilane, butyltrimethoxysilane, butyltriethoxysilane, pentyltrimethoxysilane, pentyltriethoxysilane, heptyltrimethoxysilane, heptyltriethoxysilane, octyltrimethoxysilane, octyltriethoxysilane, dodecyltrimethoxysilane, dodecyltriethoxysilane, hexadecyltrimethoxysilane, hexadecyltriethoxysilane, octadecyltrimethoxysilane, octadecyltriethoxysilane, phenyltrimethoxysilane, phenyltriethoxysilane, vinyltrimethoxysilane, vinyltriethoxysilane, γ-aminopropyltrimethoxysilane, γ-aminopropyltriethoxysilane, γ-glycidoxypropyltrimethoxysilane, γ-glycidoxypropyltriethoxysilane, γ-methacryloxypropyltrimethoxysilnae and γmethacryloxypropyltriethoxysilane, γ-ureidopropyltrimethoxysilane, γ-ureidopropyltriethoxysilane, and dialkoxysilanes such as dimethyldimethoxysilane and dimethyldiethoxysilane, and trialkoxysilanes such as trimethylmethoxysilane and trimethylethoxysilane. These modifiers may be used alone or in combination as a mixture of two or more of them.

Such a modifier (E) is capable of lowering the temperature for curing the coating on the substrate and improves the adhesion of the coating film to the substrate. The reaction mixture comprising the silicon compounds (A) and (B), the alcohol (C) and the oxalic acid (D) may be formed by mixing such components, or by further incorporating the above modifier (E) thereto. To such a reaction mixture, no water may be added. This reaction mixture is preferably heated in the form of a solution. For example, it is preferably heated as a reaction mixture in the form of a solution obtained by preliminarily adding the oxalic acid (D) to the alcohol (C) to form an alcohol solution of oxalic acid and then mixing the silicon compounds (A) and (B) and the above modifier (E). The reaction mixture comprising the silicon compounds (A) and (B), the alcohol (C) and the oxalic acid (D) in the above mentioned ratio, usually has a SiO₂ concentration of from 0.5 to 10 wt % when silicon atoms contained therein are calculated as SiO₂. Also in the case of the reaction mixture containing the above modifier (E), such a modifier (E) is incorporated so that the mixture will have a SiO₂ concentration of from 0.5 to 10 wt % when silicon atoms contained therein are calculated as SiO₂. Such a reaction mixture is maintained at the above SiO₂ concentration and in the absence of water during the heating of the reaction mixture. This heating can be carried out in a usual reactor at a liquid temperature of from 50 to 180° C. Preferably, it is carried out, for example, in a closed container or under reflux, so that no evaporation or volatilization of the liquid from the reactor occurs.

In the formation of the reaction mixture, a fluoroalkyl group-containing alkylalkoxysilane (F) may be used in combination with the silicon compound (B), for example, in such an amount that the total amount of the silicon compound (B) and the fluoroalkyl group-containing alkoxysilane (F) will be from about 0.05 to 0.43 mol per mol of the silicon compound (A), as the case requires, in addition to the silicon compounds (A) and (B), the alcohol (C), the oxalic acid (D), etc. Preferred examples of the fluoroalkyl group-containing alkylalkoxysilane (F) include trifluoropropyltrimethoxysilane, trifluoropropyltriethoxysilane, tridecafluorooctyltrimethoxysilane, tridecafluorooctyltriethoxysilane, heptadecafluorodecyltrimethoxysilane and heptadacafluorodecyltriethoxysilane, and they may be used alone or in combination as a mixture of two or more of them.

Such a fluoroalkyl group-containing alkylalkoxysilane (F) is capable of suppressing an excessive copolymerization reaction of the silicon compounds (A) and (B) thereby to form a polysiloxane solution which can be stored for a long period of time. The reaction mixture comprising the silicon compounds (A) and (B), the alcohol (C) and the oxalic acid (D) may be formed by mixing such components, or by further incorporating the above fluoroalkyl group-containing alkylalkoxysilane (F) thereto. To such a reaction mixture, no water may be added. This reaction mixture is preferably heated in the form of a solution. For example, it is preferably heated as a reaction mixture in the form of a solution obtained by preliminarily adding the oxalic acid (D) to the alcohol (C) to form an alcohol solution of oxalic acid and then mixing such a solution with the silicon compounds (A) and (B), the above fluoroalkyl group-containing alkoxysilane (F), etc. The reaction mixture comprising the silicon compounds (A) and (B), the alcohol (C) and the oxalic acid (D) in the above mentioned ratio, usually has a SiO₂ concentration of from 0.5 to 10 wt % when silicon atoms contained therein are calculated as SiO₂. Also in the case of the reaction mixture containing the above fluoroalkyl group-containing alkylalkoxysilane (F), such a fluoroalkyl group-containing alkylalkoxysilane (F) is incorporated so that the mixture will have a SiO₂ concentration of from 0.5 to 10 wt % when silicon atoms contained therein are calculated as SiO₂. Such a reaction mixture is maintained at the above SiO₂ concentration and in the absence of water during the heating of the reaction mixture. This heating can be carried out in a usually reactor at a liquid temperature of from 50 to 180° C. Preferably, it is carried out, for example, in a closed container or under reflux, so that no evaporation or volatilization of the liquid from the reactor occurs.

If the heating to form the polysiloxane is carried out at a temperature lower than 50° C., the liquid tends to have turbidity or tends to contain insoluble substances. Therefore, this heating is carried out at a temperature higher than 50° C. If the temperature is high, the operation can be completed in a short period of time. However, heating at a temperature higher than 180° C. is inefficient, as no additional merits will be thereby obtained. The heating time is not particularly limited. For example, it is usually about 8 hours at 50° C. and about 3 hours under reflux at 78° C. Usually, the heating is terminated when the amount of the remaining silicon compounds (A) and (B) becomes at most 5 mol %, based on the total charge amount of the silicon compounds (A) and (B). If a polysiloxane-containing liquid in which these silicon compounds remain more than 5% based on the total amount of the silicon compounds (A) and (B) charged, is applied on a substrate surface and then the coating is heat-cured at a temperature of from 80 to 450° C., the resulting coating film tends to have pinholes, or it tends to be difficult to obtain a coating film having adequate hardness.

The polysiloxane solution obtained by the above heating, may be used directly as a coating fluid for the next coating step. However, if desired, it may be concentrated or diluted to obtain a solution useful as a coating fluid, or the solvent may be substituted by other solvent to obtain a solution useful as a coating fluid. Otherwise, an optional additive (G) may be added thereto to obtain a coating fluid. Examples of such an additive (G) include a silica sol, an alumina sol, a titania sol, a zirconia sol, a magnesium fluoride sol and a ceria sol, which are in the form of sols of colloidal inorganic fine particles. These sols may be used alone or in combination as a mixture of two or more of them. Such sols are preferably organo sols. Particularly preferred are organo sols using the alcohol (C) as the dispersing medium. The amount of the sol to be added, may be selected optionally, so long as the amount of colloidal inorganic fine particles is at most 70 wt %, based on the total weight of the heat cured solid content in the coating fluid. As other additives (G), metal salts or metal compounds may, for example, be mentioned. These additives are suitable for controlling the water repellency of the coating film.

The coating fluid to be used in the coating step, is preferably a fluid which contains from 0.5 to 10 wt %, as calculated as SiO₂ of silicon atoms derived from the above polysiloxane transparent solution. If this SiO₂ concentration is less than 0.5%, the thickness of the coating film formed by one coating operation tends to be thin. If the concentration exceeds 10 wt %, the storage stability of such a coating fluid tends to be inadequate. It is particularly preferred that the SiO₂ concentration of this coating fluid is from 2 to 8 wt %.

The substrate is not particularly limited so long as it permits formation of an adhesive coating film thereon. In order to form an antireflection coating film thereon, it is preferred to use a substrate having a refractive index higher than the refractive index of the coating film, such as usual glass or plastics. The above polysiloxane solution or a coating fluid comprising such as solution, can be applied on the substrate by a conventional method such as a dipping method, a spin coating method, a brush coating method, a roll coating method or a flexo printing method.

The coating formed on the substrate may directly be heat-cured. However, prior to such heat-curing, it may be dried at a temperature of from room temperature to 80° C., preferably from 50 to 80° C., and then heated at a temperature of from 80 to 450° C., preferably from 100 to 450° C. The time for this heating may be from 5 to 60 minutes for adequate heat-curing. If this heating temperature is lower than 80° C., the hardness, chemical resistance or the like of the resulting coating film tends to be inadequate. In the case of a heat resistant substrate such as glass, heating may usually be carried out at a temperature of at least 300° C. However, at a temperature higher than 450° C., no adequate water repellency tends to be imparted to the resulting coating film. Such heating can be carried out by a conventional method, for example, by using a hot plate, an oven or a belt furnace.

### EXAMPLES

Now, the present invention will be described with reference to Examples. However, it should be understood that the present invention is by no means restricted to such Examples.

Gas Chromatography (GC)

In Examples 1, 2, 3 and 4, and Comparative Example 1, the remaining alkoxysilane monomer after the reaction was confirmed by means of gas chromatography.

Conditions for gas chromatography: Apparatus: Shimadzu GC-14B, column: capillary column CBP1-W25-100 (25 mm×0.53 mmφ×1 μm), column temperature: the column temperature was controlled by using a temperature raising program. The temperature was raised from the initial temperature of 50° C. at a rate of 15° C./min to the ultimate temperature of 290° C. (3 minutes).

Injected amount of sample: 1 μm, injection temperature: 240° C., detector temperature: 290° C., carrier gas: nitrogen (flow rate 30 mL/min), detection method: FID method.

### Example 1

72.1 g of methanol was charged into a four-necked reaction flask equipped with a reflux condenser, and 12.1 g of oxalic acid was gradually added to this methanol with stirring, to prepare a methanol solution of oxalic acid. Then, this solution was heated to its reflux temperature, and a mixture comprising 8.4 g of tetraethoxysilane and 7.4 g of 1,6-bis(trimethoxysilylethyl)perfluorohexane, was dropwise added to this solution under reflux. After completion of the dropwise addition, heating under reflux was continued for 5 hours, followed by cooling to obtain a polysiloxane solution (L₁).

This solution (L₁) was analyzed by gas chromatography, whereby no alkoxysilane monomer was detected. This solution (L₁) was applied on the surface of a calcium fluoride substrate, and then the coating was heated at 300° C. for 30 minutes to form a coating film adhered to the surface of this calcium fluoride substrate. Then, with respect to this coating film, the spectrum of transmitted light was measured by means of an infrared spectroscope, whereby absorption by a silanol group was observed in the vicinity of 3,200 cm⁻¹ and in the vicinity of 980 cm⁻¹, absorption by a methylene group was observed in the vicinity of 2,800 cm⁻¹, absorption by Si—O—Si was observed in the vicinity of 1,100 cm⁻¹, and absorption by C—F was observed in the vicinity of 1,200 cm⁻¹.

### Example 2

71.3 g of ethanol was charged into a four-necked reaction flask equipped with a reflux condenser, and 12.1 g of oxalic acid was gradually added to this ethanol with stirring, to prepare an ethanol solution of oxalic acid. Then, this solution was heated to its reflux temperature, and a mixture comprising 9.8 g of tetraethoxysilane, 3.1 g of tridecafluorooctyltrimethoxysilane and 3.7 g of 1,6-bis(trimethoxysilylethyl)perfluorohexane, was dropwise added to this solution under reflux. After completion of the dropwise addition, heating was continued for 5 hours under reflux, followed by cooling to obtain a polysiloxane solution (L₂).

This solution (L₂) was analyzed by gas chromatography, whereby no alkoxysilane monomer was detected.

### Example 3

71.1 g of ethanol was charged into a four-necked reaction flask equipped with a reflux condenser, and 12.1 g of oxalic acid was gradually added to this ethanol with stirring, to prepare an ethanol solution of oxalic acid. Then, this solution was heated to its reflux temperature, and a mixture comprising 8.1 g of tetraethoxysilane, 3.1 g of tridecafluorooctyltrimethoxysilane, 3.7 g of 1,6-bis(trimethoxysilylethyl)perfluorohexane, 1.3 g of γ-glycidoxypropyltrimethoxysilane and 0.6 g of γ-aminopropyltrimethoxysilane, was dropwise added to this solution under reflux. After completion of the dropwise addition, heating was continued for 5 hours under reflux, followed by cooling to obtain a polysiloxane solution (L₃). This solution (L₃) was analyzed by gas chromatography, whereby no alkoxide monomer was detected.

### Example 4

67.5 g of methanol was charged into a four-necked reaction flask equipped with a reflux condenser, and 12.1 g of oxalic acid was gradually added to this methanol with stirring, to prepare a methanol solution of oxalic acid. Then, this solution was heated to its reflux temperature, and a mixture comprising 9.1 g of tetraethoxysilane, 3.1 g of tridecafluorooctyltrimethoxysilane, 3.7 g of 1,6-bis(trimethoxysilylethyl)perfluorohexane, 0.9 g of γ-ureidopropyltriethoxysilane and 3.6 g of methanol, was dropwise added to this solution under reflux. After completion of the dropwise addition, heating was continued for 5 hours under reflux, followed by cooling to obtain a polysiloxane solution (L₄). This solution (L₄) was analyzed by gas chromatography, whereby no alkoxide monomer was detected.

### Example 5

To 25.0 g of the solution (L₃) obtained in Example 3, 19.1 g of a methanol-dispersed silica sol containing 15.7 wt % as SiO₂ of colloidal silica having a particle size of 8 nm, and 55.9 g of ethanol, were added and thoroughly mixed to obtain a polysiloxane solution (L₅).

### Comparative Example 1

70.6 g of ethanol was charged into a four-necked reaction flask equipped with a reflux condenser, and 12.0 g of oxalic acid was gradually added to this ethanol with stirring, to prepare an ethanol solution of oxalic acid. Then, this solution was heated to its reflux temperature, and a mixture comprising 9.4 g of tetraethoxysilane, 6.2 g of tridecafluorooctyltrimethoxysilane [CF₃C₅F₁₀C₂H₄Si(OCH₃)₃], 1.2 g of γ-glycidoxypropyltrimethoxysilane and 0.6 g of γ-aminopropyltrimethoxysilane, was dropwise added to this solution under reflux. After completion of the dropwise addition, heating was continued for 5 hours under reflux, followed by cooling to obtain a polysiloxane solution (L₆). This solution (L₆) was analyzed by gas chromatography, whereby no alkoxide monomer was detected.

### Comparative Example 2

To 25.0 g of the solution (L₆) obtained in Comparative Example 1, 19.1 g of a methanol-dispersed silica sol containing 15.7 wt % as SiO₂ of colloidal silica having a particle size of 8 nm, and 55.9 g of ethanol, were added and thoroughly mixed to obtain a polysiloxane solution (L₇).

### Comparative Example 3

Into a four-necked reaction flask equipped with a reflux condenser, a mixture comprising 58.7 g of ethanol, 8.4 g of tetraethoxysilane and 7.4 g of 1,6-bis(trimethoxysilylethyl)perfluorohexane, was charged and mixed to prepare an ethanol solution of the alkoxysilanes. Then, this solution was heated to its reflux temperature, and a mixture comprising 20.0 g of ethanol, 5.4 g of water and 0.1 g of 60% nitric acid as a catalyst, was dropwise added to this solution under reflux. After completion of the dropwise addition, the heating was continued for 5 hours under reflux, followed by cooling to obtain a solution (L₈) containing hydrolysates of alkoxysilanes.

### Example 6

Each of the above liquids (L₁) to (L₈) was used as a coating fluid, and coating was formed by means of a bar coater on a hard coat-covered TAC film (80 μm, reflectance: 4.5%) manufactured by Nippon Paper Industries Co., Ltd. surface-treated by the following method, and then dried at room temperature for 30 minutes. It was further heated in a clean oven for one hour at the temperature shown in Table 1, to form a coating film on the substrate surface. Then, with respect to each coating film thus obtained, measurements of the refractive index, the reflectance and the contact angle with water, and tests for oil-based ink wiping efficiency and finger print wiping efficiency, were carried out by the following methods. For the measurement of the refractive index, the coating film was formed by spin coating on a silicon substrate.

Method for Surface Treatment of Tac Film

A hard coat-covered TAC film manufactured by Nippon Paper Industries Co., Ltd. was immersed in a 5 wt % potassium hydroxide (KOH) aqueous solution heated to 40° C. for 3 minutes for alkali treatment, then washed with water and then immersed in a 0.5 wt % sulfuric acid (H₂SO₄) aqueous solution at room temperature for 30 minute for neutralization, followed by washing with water and drying.

Method for Measuring Refractive Index

Using Ellipsometer DVA-36L, manufactured by Mizojiri Kogaku K. K., the refractive index of light with a wavelength of 633 nm was measured.

Method for Measuring Reflectance

Using spectrophotometer UV 3100 PC, manufactured by Shimadzu Corporation, the reflectance of light with a wavelength of 550 nm was measured at an angle of incidence of 5°.

Method for Measuring Contact Angle with Water

Using an automatic contact angle meter CA-Z model, manufactured by Kyowa Kaimen Kagaku K.K., the contact angle when 3 μl of pure water was dropped, was measured.

Oil-Based Ink Wiping Test

Using an oil-based ink pen, manufactured by PENTEL CO., LTD., an ink drawn on a substrate surface, was wiped off by means of BEMCOT M-3, manufactured by Asahi Kasei Corporation, whereby the wiping off efficiency was visually evaluated. The evaluation standards are as follows.

A: Ink can completely be wiped off. B: Ink can be wiped off, but a trace will remain. C: Ink can not be wiped off.

Finger Print Wiping Test

A finger print on a substrate surface was wiped off by means of BEMCOT M-3, manufactured by Asahi Kasei Corporation, whereby the wiping off efficiency was visually evaluated.

The evaluation standards are as follows.

A: The finger print can be completely wiped off. B: The finger print can be wiped off, but a trace will remain, or the trace may be removed but the finger print will stretch. C: The finger print can not be wiped off.

Abrasion Resistance

Steel wool #0000, manufactured by Nippon Steel Wool K.K. was reciprocated ten times for abrasion under a load of 200 g/cm² or 500 g/cm², whereupon scratch marks were visually evaluated.

The evaluation standards are as follows.

A: No scratch observed. B: Less than ten scratch marks observed. C: From 10 to 30 scratch marks observed. D: More than 30 scratch marks observed.

Adhesion

A cured coating film on a substrate was cross-cut at 1 mm intervals for 100 sections, and an adhesive tape (trade name: Cellotape, manufactured by NICHIBAN CO., LTD., 24 mm) was firmly bonded to the cured coating film and then, the adhesive tape was rapidly peeled, whereupon the presence or absence of peeling of the cured film was visually observed.

TABLE 1

| | Temperature | | | Abrasion | |
|---|---|---|---|---|---|
| Coating | for curing | Refractive | Reflectance | resistance | |
| fluid | (° C.) | index | (%) | 200 g | 500 g |
| L₁ | 100 | 1.36 | 1.2 | B | C |
| L₂ | 100 | 1.36 | 1.2 | B | D |
| L₃ | 70 | 1.38 | 1.8 | B | D |
| L₃ | 100 | 1.38 | 1.8 | A | C |
| L₃ | 120 | 1.38 | 1.8 | A | B |
| L₄ | 100 | 1.37 | 1.4 | A | A |
| L₅ | 100 | 1.39 | 1.9 | B | D |
| L₆ | 100 | 1.38 | 1.7 | D | D |
| L₇ | 100 | 1.39 | 1.9 | C | D |
| L₈ | 100 | 1.39 | 1.9 | C | D |

TABLE 2

| | Temperature | Contact | Oil-based | Finger pint | |
|---|---|---|---|---|---|
| Coating | for curing | angle with | ink wiping | wiping | |
| fluid | (° C.) | water (°) | efficiency | efficiency | Adhesion |
| L₁ | 100 | 104 | A | A | 100/100 |
| L₂ | 100 | 104 | A | A | 100/100 |
| L₃ | 70 | 105 | A | A | 100/100 |
| L₃ | 100 | 105 | A | A | 100/100 |
| L₃ | 120 | 105 | A | A | 100/100 |
| L₄ | 100 | 104 | A | A | 100/100 |
| L₅ | 100 | 105 | A | A | 100/100 |
| L₆ | 100 | 104 | A | A | 100/100 |
| L₇ | 100 | 102 | B | A | 100/100 |
| L₈ | 100 | 100 | B | B | 0/100 |

As shown in Table 1, coating films having low refractive indices, low reflectance and good abrasion resistance, were obtained from the coating fluids of the present invention (L₁ to L₅). Whereas, with the coatings obtained from the coating fluids of Comparative Examples (L₆ to L₈), the abrasion resistance was not sufficient, although they had low refractive indices and low reflectance.

Further, as shown in Table 2, each of the coatings obtained from the coating fluids (L₁ to L₅) had excellent antifouling properties and was excellent in adhesion to the substrate. Whereas, with coating fluid L₇ of Comparative Example, the oil-based ink antifouling property was inadequate, and with coating fluid L₈ of Comparative Example, both the antifouling properties and adhesion were inadequate.

### INDUSTRIAL APPLICABILITY

The coating film of the present invention may be applied to the surface of various products for which antireflection of light is desired, including cathode ray tubes made of glass, displays for computers, mirrors having glass surface and showcases made of glass. Further, the coating film of the present invention is highly hard and excellent in abrasion resistance and has a practically sufficient antifouling property, and it is possible to form such a coating film by baking at a low temperature at a level of about 100° C. Thus, it is useful particularly for an antireflection film for liquid crystal TV of display monitors.

1. A process for preparing a coating fluid containing a polysiloxane, which comprises forming a reaction mixture comprising a silicon compound (A) of the formula (1):
Si(OR)₄ (1)
wherein R is a C₁₋₅ alkyl group, a silicon compound (B) of the formula (2):
(R¹O)₃SiCH₂CH₂(CF₂)ₙCH₂CH₂Si(OR¹)₃ (2)
wherein R¹ is a C₁₋₅ alkyl group, and n is an integer of from 1 to 13, an alcohol (C) of the formula (3):
R²CH₂OH (3)
wherein R² is a hydrogen atom or a C₁₋₁₂ alkyl group wherein the alkyl group is optionally be substituted by one or more substituents of the same or different types selected from the group consisting of a C₁₋₃ alkyl group, a C₁₋₃ hydroxyalkyl group, a C₂₋₆ alkoxyalkyl group, a C₂₋₆ hydroxyalkoxyalkyl group and a C₃₋₆ alkoxyalkoxyalkyl group, and oxalic acid (D), in a ratio of from 0.05 to 0.43 mol of the silicon compound (B) per mol of the silicon compound (A), in a ratio of from 0.5 to 100 mol of the alcohol (C) per mol of the total alkoxy groups contained in the silicon compounds (A) and (B) and in a ratio of 0.2 to 2 mol of the oxalic acid (D) per mol of the total alkoxy groups contained in the silicon compounds (A) and (B), and heating the reaction mixture at a temperature of from 50 to 180° C. until the total amount of the silicon compounds (A) and (B) remaining in the reaction mixture becomes at most 5 mol %, while maintaining a SiO₂ concentration of from 0.5 to 10 wt % as calculated from silicon atoms in the reaction mixture and in the absence of water.

2. The process for preparing a coating fluid according to claim 1, wherein in the formation of the reaction mixture, a modifier (E) of the formula (4):
(R³)ₘSi(OR⁴)₄₋ₘ (4)
wherein R³ is a hydrogen atom, a C₁₋₁₂ alkyl group wherein the alkyl group is optionally be substituted by one or more substituents selected from the group consisting of an amino group, a glycidoxy group, a methacryloxy group and a ureide group, a C₂₋₁₂ alkenyl group or a phenyl group, R⁴ is a C₁₋₅ alkyl group, and m is an integer of from 1 to 3, is further incorporated as a modifier (E) in a ratio of from 0.02 to 0.2 mol per mol of the silicon compound (A).

3. The process for preparing a coating fluid according to claim 1, wherein in the formation of the reaction mixture, a fluoroalkyl group-containing alkoxysilane (F) of the formula (5):
CF₃(CF₂)ₚCH₂CH₂Si(OR⁵)₃ (5)
wherein R⁵ is a C₁₋₅ alkyl group, and p is an integer of from 0 to 12, is further incorporated as a fluoroalkyl group-containing alkoxysilane (F) in such a ratio that the total amount of the silicon compound (B) and the fluoroalkyl group-containing alkoxysilane (F) is from 0.05 to 0.43 mol per mol of the silicon compound (A).

4. The process for preparing a coating fluid according to claim 1, wherein at least one sol selected from the group consisting of silica sol, alumina sol, titania sol, zirconia sol, magnesium fluoride sol and ceria sol is incorporated as an additive (G) to the coating fluid.

5. A process for forming a coating film, which comprises forming a reaction mixture comprising a silicon compound (A) of the formula (1):
Si(OR)₄ (1)
wherein R is a C₁₋₅ alkyl group, a silicon compound (B) of the formula (2):
(R¹O)₃SiCH₂CH₂(CF₂)ₙCH₂CH₂Si(OR¹)₃ (2)
wherein R¹ is a C₁₋₅ alkyl group, and n is an integer of from 1 to 13, an alcohol (C) of the formula (3):
R²CH₂OH (3)
wherein R² is a hydrogen atom or a C₁₋₁₂ alkyl group wherein the alkyl group is optionally be substituted by one or more substituents of the same or different types selected from the group consisting of a C₁₋₃ alkyl group, a C₁₋₃ hydroxyalkyl group, a C₂₋₆ alkoxyalkyl group, a C₂₋₆ hydroxyalkoxyalkyl group and a C₃₋₆ alkoxyalkoxyalkyl group, and oxalic acid (D), in a ratio of from 0.05 to 0.43 mol of the silicon compound (B) per mol of the silicon compound (A), in a ratio of from 0.5 to 100 mol of the alcohol (C) per mol of the total alkoxy groups contained in the silicon compounds (A) and (B) and in a ratio of 0.2 to 2 mol of the oxalic acid (D) per mol of the total alkoxy groups contained in the silicon compounds (A) and (B); heating the reaction mixture at a temperature of from 50 to 180° C. until the total amount of the silicon compounds (A) and (B) remaining in the reaction mixture becomes at most 5 mol %, while maintaining a SiO₂ concentration of from 0.5 to 10 wt % as calculated from silicon atoms in the reaction mixture and in the absence of water, forming a solution of a polysiloxane, and applying a coating fluid comprising the polysiloxane solution on a substrate surface to form a coating, and heat-curing the coating at a temperature of from 80 to 450° C., to form a coating film having a refractive index of from 1.28 to 1.38 and a contact angle with water of from 90° to 115°, as adhered to the substrate surface.

6. The process for forming a coating film according to claim 5, wherein in the formation of the reaction mixture, a modifier (E) of the formula (4):
(R³)ₘSi(OR⁴)₄₋ₘ (4)
wherein R³ is a hydrogen atom, a C₁₋₁₂ alkyl group wherein the alkyl group is optionally be substituted by one or more substituents selected from the group consisting of an amino group, a glycidoxy group, a methacryloxy group and a ureide group, a C₂₋₁₂ alkenyl group or a phenyl group, R⁴ is a C₁₋₅ alkyl group, and m is an integer of from 1 to 3, is further incorporated as a modifier (E) in a ratio of from 0.02 to 0.2 mol per mol of the silicon compound (A).

7. The process for preparing a coating film according to claim 5, wherein in the formation of the reaction mixture, a fluoroalkyl group-containing alkoxysilane (F) of the formula (5):
CF₃(CF₂)ₚCH₂CH₂Si(OR⁵)₃ (5)
wherein R⁵ is a C₁₋₅ alkyl group, and p is an integer of from 0 to 12, is further incorporated as a fluoroalkyl group-containing alkoxysilane (F) in such a ratio that the total amount of the silicon compound (B) and the fluoroalkyl group-containing alkoxysilane (F) is from 0.05 to 0.43 mol per mol of the silicon compound (A).

8. The process for forming a coating film according to claim 5, wherein at least one sol selected from the group consisting of silica sol, alumina sol, titania sol, zirconia sol, magnesium fluoride sol and ceria sol is incorporated as an additive (G) to the coating fluid.

9. A coating film having a refractive index of from 1.28 to 1.38 and a contact angle with water of from 90° to 115°, which is formed as adhered to a substrate surface by forming a reaction mixture comprising a silicon compound (A) of the formula (1):
Si(OR)₄ (1)
wherein R is a C₁₋₅ alkyl group, a silicon compound (B) of the formula (2):
(R¹O)₃SiCH₂CH₂(CF₂)ₙCH₂CH₂Si(OR¹)₃ (2)
wherein R¹ is a C₁₋₅ alkyl group, and n is an integer of from 1 to 13, an alcohol (C) of the formula (3):
R²CH₂OH (3)
wherein R² is a hydrogen atom or a C₁₋₁₂ alkyl group wherein the alkyl group is optionally be substituted by one or more substituents of the same or different types selected from the group consisting of a C₁₋₃ alkyl group, a C₁₋₃ hydroxyalkyl group, a C₂₋₆ alkoxyalkyl group, a C₂₋₆ hydroxyalkoxyalkyl group and a C₃₋₆ alkoxyalkoxyalkyl group and oxalic acid (D), in a ratio of from 0.05 to 0.43 mol of the silicon compound (B) per mol of the silicon compound (A), in a ratio of from 0.5 to 100 mol of the alcohol (C) per mol of the total alkoxy groups contained in the silicon compounds (A) and (B) and in a ratio of 0.2 to 2 mol of the oxalic acid (D) per mol of the total alkoxy groups contained in the silicon compounds (A) and (B); heating the reaction mixture at a temperature of from 50 to 180° C. until the total amount of the silicon compounds (A) and (B) remaining in the reaction mixture becomes at most 5 mol %, while maintaining a SiO₂ concentration of from 0.5 to 10 wt % as calculated from silicon atoms in the reaction mixture and in the absence of water, to form a solution of a polysiloxane, applying a coating fluid comprising the polysiloxane solution on a substrate surface to form a coating and heat-curing the coating at a temperature of from 80 to 450° C.

10. The coating film according to claim 9, wherein in the formation of the reaction mixture, a modifier (E) of the formula (4):
(R³)ₘSi(OR⁴)₄₋ₘ (4)
wherein R³ is a hydrogen atom, a C₁₋₁₂ alkyl group wherein the alkyl group is optionally be substituted by one or more substituents selected from the group consisting of an amino group, a glycidoxy group, a methacryloxy group and a ureide group, a C₂₋₁₂ alkenyl group or a phenyl group, R⁴ is a C₁₋₅ alkyl group, and m is an integer of from 1 to 3, is further incorporated as a modifier (E) in a ratio of from 0.02 to 0.2 mol per mol of the silicon compound (A).

11. The coating film according to claim 9, wherein in the formation of the reaction mixture, a fluoroalkyl group-containing alkoxysilane (F) of the formula (5):
CF₃(CF₂)ₚCH₂CH₂Si(OR⁵)₃ (5)
wherein R⁵ is a C₁₋₅ alkyl group, and p is an integer of from 0 to 12, is further incorporated as a fluoroalkyl group-containing alkoxysilane (F) in such a ratio that the total amount of the silicon compound (B) and the fluoroalkyl group-containing alkoxysilane (F) is from 0.05 to 0.43 mol per mol of the silicon compound (A).

12. The coating film according to claim 9, wherein at least one sol selected from the group consisting of silica sol, alumina sol, titania sol, zirconia sol, magnesium fluoride sol and ceria sol is further incorporated as an additive (G) to the coating fluid.
